(19) United States
(12) Patent Application Publication
(10) Pub. No.: US 2013/0057553 A1
(43) Pub. Date: Mar. 7, 2013

(54) Smart Display with Dynamic Font Management

(71) Applicants: Hari Chakravarthula, San Jose, CA (US); Tomaso Paoletti, San Mateo, CA (US); Avinash Uppuluri, Sunnyvale, CA (US)

(72) Inventors: Hari Chakravarthula, San Jose, CA (US); Tomaso Paoletti, San Mateo, CA (US); Avinash Uppuluri, Sunnyvale, CA (US)

(73) Assignee: DigitalOptics Corporation Europe Limited, Galway (IE)

(21) Appl. No.: 13/294,977

(22) Filed: Nov. 11, 2011

Related U.S. Application Data
(60) Provisional application No. 61/530,872, filed on Sep. 2, 2011.

(51) Int. Cl. G06T 11/00

(52) U.S. Cl. 345/468; 345/472

(57) ABSTRACT

An electronic display is provided that can include any number of features. In some embodiments, the display includes sensors, such as a camera, configured to detect a user parameter of a user positioned before the display. The user parameter can be, for example, an age of the user or a distance of the user from the screen. The display can include a processor configured to adjust a font or icon size on the display based on the detected user parameter.

### CROSS REFERENCE TO RELATED APPLICATIONS

This application claims the benefit under 35 U.S.C. 119 of U.S. Provisional Patent Application No. 61/530,872, filed Sep. 2, 2011, titled “Smart Display with Dynamic Font Management”.

This application is related to U.S. application Ser. No. 13/035,907, filed on Feb. 25, 2011, and co-pending U.S. application Ser. No. 13/294,964, filed on the same day as this application, titled “Smart Display with Dynamic Face-Based User Preference Settings”.

### INCORPORATION BY REFERENCE

All publications and patent applications mentioned in this specification are herein incorporated by reference to the same extent as if each individual publication or patent application was specifically and individually indicated to be incorporated by reference.

### FIELD

This disclosure relates generally to display devices. More specifically, this disclosure relates to computing displays or television monitors.

### BACKGROUND

Electronic display devices are commonly used as television sets or with computers to display two-dimensional images to a user. In the case of computing, electronic display devices provide a visual interaction with the operating system of the computer.

In most cases, a user provides input to a computer with the use of an external input device, most commonly with the combination of a keyboard and a mouse or trackball. However, more recently, touchscreen devices (e.g., capacitive or resistive touchscreens) built into electronic displays have gained popularity as an alternative means for providing input to a computing device or television display.

Electronic displays have evolved from large, heavy cathode ray tube monitors (CRT) to lighter, thinner liquid crystal displays (LCD) and organic light emitting diode (OLED) displays. Many displays now incorporate additional features, such as cameras and universal serial bus (USB) ports, to improve the computing or television experience.

### SUMMARY OF THE DISCLOSURE

A method of dynamically changing a display parameter is provided, comprising detecting a user parameter of a user positioned before an electronic display, and automatically adjusting a font size of text on the display based on the detected user parameter.

In some embodiments, the user parameter is an age of the user.

In one embodiment, the font size is increased when the user is elderly. In another embodiment, the font size is decreased when the user is a child or young adult.

In some embodiments, the user parameter is a distance from the user to the electronic display.

In one embodiment, the font size is increased when the distance is greater than an optimal distance. In another embodiment, the font size is decreased when the distance is less than an optimal distance.

In some embodiments, the font size changes dynamically in real time as the distance from the user to the electronic display changes.

In other embodiments, the font size is decreased in real time as the distance from the user to the electronic display becomes smaller, wherein the font size is increased in real time as the distance from the user to the electronic display becomes larger.

In some embodiments, the detecting step comprises detecting the user parameter with a sensor disposed on or near the electronic display. In one embodiment, the sensor comprises a camera.

In some embodiments, the electronic display comprises a computer monitor. In other embodiments, the display comprises a cellular telephone.

In one embodiment, the automatically adjusting step comprises processing the user parameter with a controller and automatically adjusting the font size of text on the display with the controller based on the detected user parameter.

A method of dynamically changing a display parameter is also provided, comprising detecting a user parameter of a user positioned before an electronic display, and automatically adjusting an icon size on the display based on the detected user parameter.

In some embodiments, the user parameter is an age of the user.

In one embodiment, the icon size is increased when the user is elderly. In another embodiment, the icon size is decreased when the user is a child or young adult.

In some embodiments, the user parameter is a distance from the user to the electronic display.

In one embodiment, the icon size is increased when the distance is greater than an optimal distance. In other embodiments, the icon size is decreased when the distance is less than an optimal distance.

In some embodiments, the detecting step comprises detecting the user parameter with a sensor disposed on or near the electronic display. In one embodiment, the sensor comprises a camera.

In some embodiments, the electronic display comprises a computer monitor. In other embodiments, the display comprises a cellular telephone.

In some embodiments, the automatically adjusting step comprises processing the user parameter with a controller and automatically adjusting the font size of text on the display with the controller based on the detected user parameter.

In other embodiments, the icon size changes dynamically in real time as the distance from the user to the electronic display changes.

In one embodiment, the icon size is decreased in real time as the distance from the user to the electronic display becomes smaller, wherein the icon size is increased in real time as the distance from the user to the electronic display becomes larger.

An electronic display is provided, comprising a sensor configured to determine a user parameter of a user positioned before the display, a screen configured to display text or images to the user, and a processor configured to adjust a size of the text or images based on the determined user parameter.

In some embodiments, the user parameter is age.

In another embodiment, the user parameter is a distance from the user to the electronic display.

In some embodiments, the sensor comprises a camera.

In another embodiment, the electronic display comprises a computer monitor. In an additional embodiment, the electronic display comprises a cellular telephone. In some embodiments, the electronic display comprises a tablet computer.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is an illustration of a user in the field of view of a display.

FIGS. 2A-2B illustrate adjusting the size of text on a display based on the age of the user.

FIGS. 3A-3B illustrate adjusting the size of icons on a display based on the age of the user.

FIGS. 4A-4B illustrate adjusting the size of text and/or icons on a display based on the distance of the user from the display.

### DETAILED DESCRIPTION

Techniques and methods are provided to adjust user preference settings based on parameters or conditions detected by a display system or monitor device. In some embodiments, the display system can detect and/or determine an age of a user. In another embodiment, the display system can detect and/or determine a distance between the user and the display. In yet another embodiment, the display system can detect and/or determine ambient light or the amount of light on a face of the user, either alone or in combination with the age or distance conditions detected above. In some embodiments, the display system can recognize a user's face, and can additionally recognize a user's gaze or determine the pupil diameter of the user.

Any number of user preferences or display settings can be dynamically adjusted based on the parameter or condition detected or determined by the display. For example, in one embodiment, font size or icon size can be adjusted based on the detected age of the user. In another embodiment, the font size or icon size can be adjusted based on the detected distance of the user from the display. In some embodiments, specific users are recognized individually, and font or icon size can be individually tailored to the specific individual recognized by the display.

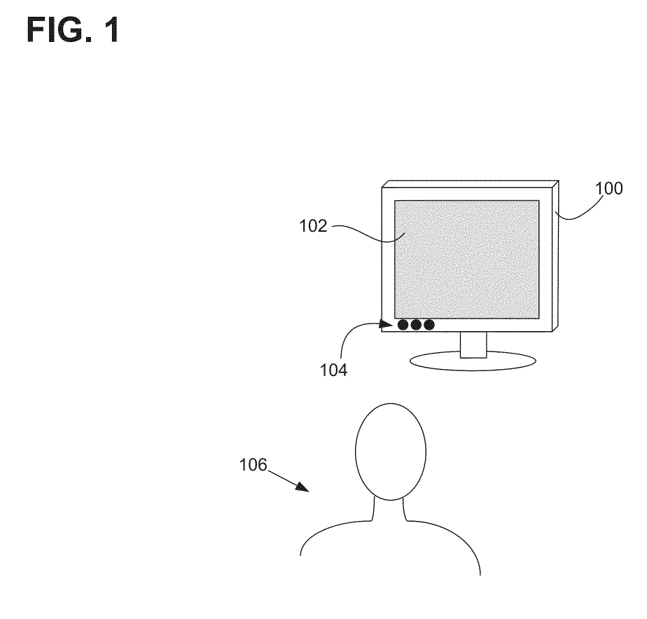

FIG. 1 illustrates a display 100, such as a computer monitor, a television display, a cellular telephone display, a tablet display, or a laptop computer display, having a screen 102 and a plurality of sensors 104. The sensors can include, for example, an imaging sensor such as a camera including a CCD or CMOS sensor, a flash or other form of illumination, and/or any other sensor configured to detect or image objects, such as ultrasound, infrared (IR), or heat sensors. The sensors can be disposed on or integrated within the display, or alternatively, the sensors can be separate from the display. Any number of sensors can be included in the display. In some embodiments, combinations of sensors can be used. For example, a camera, a flash, and an infrared sensor can all be included in a display in one embodiment. It should be understood that any combination or number of sensors can be included on or near the display. As shown in FIG. 1, user 106 is shown positioned before the display 100, within detection range or field of view of the sensors 104.

Various embodiments involve a camera mounted on or near a display coupled with a processor programmed to detect, track and/or recognize a face or partial face, or a face region, such as one or two eyes, or a mouth region, or a facial expression or gesture such as smiling or blinking. In some embodiments, the processor is integrated within or disposed on the display. In other embodiments, the processor is separate from the display. The processor can include memory and software configured to receive signals from the sensors and process the signals. Certain embodiments include sensing a user or features of a user with the sensors and determining parameters relating to the face such as orientation, pose, tilt, tone, color balance, white balance, relative or overall exposure, face size or face region size including size of eyes or eye regions such as the pupil, iris, sclera or eye lid, a focus condition, and/or a distance between the camera or display and the face. In this regard, the following are hereby incorporated by reference as disclosing alternative embodiments and features that may be combined with embodiments or features of embodiments described herein: U.S. patent application Ser. Nos. 13/035,907, filed Feb. 25, 2011, 12/883,183, filed Sep. 16, 2010 and 12/944,701, filed Nov. 11, 2010, each by the same assignee, and U.S. Pat. Nos. 7,853,043, 7,844,135, 7,715,597, 7,620,218, 7,587,068, 7,565,030, 7,564,994, 7,558,408, 7,555,148, 7,551,755, 7,460,695, 7,460,694, 7,403,643, 7,317,815, 7,315,631, and 7,269,292.

Many techniques can be used to determine the age of a user seated in front of a display or monitor. In one embodiment, the age of the user can be determined based on the size of the user's eye, the size of the user's iris, and/or the size of the user's pupil.

Depending on the sensors included in the display, an image or other data on the user can be acquired by the display with the sensors, e.g., an image of the user. Meta-data on the acquired date, including the distance to the user or object, the aperture, CCD or CMOS size, focal length of the lens and the depth of field, can be recorded on or with the image at acquisition. Based on this information, the display can determine a range of potential sizes of the eye, the iris, the pupil, or red eye regions (if a flash is used).

The variability in this case is not only for different individuals, but also variability based on age. Luckily, in the case of eyes, the size of the eye is relatively constant as a person grows from a baby into an adult, this is the reason of the striking effect of “big eyes” that is seen in babies and young children. The average infant's eyeball measures approximately 19.5 millimeters from front to back, and as described above, grows to 24 millimeters on average during the person's lifetime. Based on this data, in case of eye detection, the size of the object which is the pupil which is part of the iris, is limited, when allowing some variability to be:

9 mm≦Size Of Iris≦13 mm

As such, by detecting or determining the size of the eye of a user with sensors 104, the age of the user can be calculated. Further details on the methods and processes for determining the age of a user based on eye, iris, or pupil size can be found in U.S. Pat. No. 7,630,006 to DeLuca et al.

In another embodiment, human faces may be detected and classified according to the age of the subjects (see, e.g., U.S. Pat. No. 5,781,650 to Lobo et al.). A number of image processing techniques may be combined with anthropometric data on facial features to determine an estimate of the age category of a particular facial image. In a preferred embodiment, the facial features and/or eye regions are validated using anthropometric data within a digital image. The reverse approach may also be employed and may involve a probability inference, also known as Bayesian Statistics.

In addition to determining the age of the user, the display can also determine or detect the distance of the user to the display, the gaze, or more specifically, the location and direction upon which the user is looking, the posture or amount of head tilt of the user, and lighting levels including ambient light and the amount of brightness on the user's face. Details on how to determine the distance of the user from the display, the gaze of the user, the head tilt or direction, and lighting levels are also found in U.S. Pat. No. 7,630,006 to DeLuca et al, and U.S. application Ser. No. 13/035,907.

Distance can be easily determined with the use of an IR sensor or ultrasound sensor. In other embodiments, an image of the user can be taken with a camera, and the distance of the user can be determined by comparing the relative size of the detected face to the size of detected features on the face, such as the eyes, the nose, the lips, etc. In another embodiment, the relative spacing of features on the face can be compared to the detected size of the face to determine the distance of the user from the sensors. In yet another embodiment, the focal length of the camera can be used to determine the distance of the user from the display, or alternatively the focal length can be combined with detected features such as the size of the face or the relative size of facial features on the user to determine the distance of the user from the display.

In some embodiments, determining the gaze of the user can include acquiring and detecting a digital image including at least part of a face including one or both eyes. At least one of the eyes can be analyzed, and a degree of coverage of an eye ball by an eye lid can be determined. Based on the determined degree of coverage of the eye ball by the eye lid, an approximate direction of vertical eye gaze can be determined. The analysis of at least one of the eyes may further include determining an approximate direction of horizontal gaze. In some embodiments, the technique includes initiating a further action or initiating a different action, or both, based at least in part on the determined approximate direction of horizontal gaze. The analyzing of the eye or eyes may include spectrally analyzing a reflection of light from the eye or eyes. This can include analyzing an amount of sclera visible on at least one side of the iris. In other embodiments, this can include calculating a ratio of the amounts of sclera visible on opposing sides of the iris.

In some embodiments, the digital image can be analyzed to determine an angular offset of the face from normal, and determining the approximate direction of vertical eye gaze based in part on angular offset and in part on the degree of coverage of the eye ball by the eye lid.

Some embodiments include extracting one or more pertinent features of the face, which are usually highly detectable. Such objects may include the eyes and the lips, or the nose, eye brows, eye lids, features of the eye such as pupils, iris, and/or sclera, hair, forehead, chin, ears, etc. The combination of two eyes and the center of the lips, for example can create a triangle which can be detected not only to determine the orientation (e.g., head tilt) of the face but also the rotation of the face relative to a facial shot. The orientation of detectible features can be used to determine an angular offset of the face from normal. Other highly detectible portions of the image can be labeled such as the nostrils, eyebrows, hair line, nose bridge, and neck as the physical extension of the face.

Ambient light can be determined with an ambient light sensor, or a camera. In other embodiments, ambient light can be determined based on the relative size of a user's pupils to the size of their eyes or other facial features.

With these settings or parameters detected by the display, including age, eye, pupil, and iris size, distance from the display, gaze, head tilt, and/or ambient lighting, any number of user preference settings can be dynamically adjusted or changed to accommodate the specific user and setting. Determination of what age groups constitute a “child”, a “young adult”, and “adult”, or an “elderly” person can be pre-programmed or chosen by an administrator. In some embodiments, however, a child can be a person under the age of 15, a young adult can be a person from ages 15-17, an adult can be a person from ages 18-65, and an elderly person can be a person older than age 65.

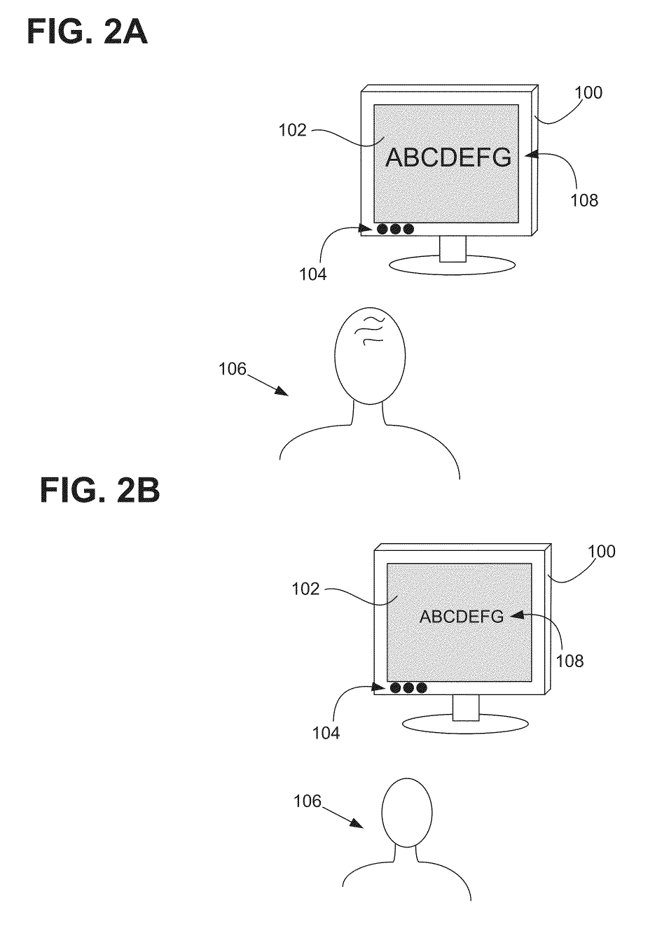

In one embodiment, the size of the font displayed on display 100 can be dynamically changed based on a detected age of the user. Referring now to FIGS. 2A-2B, in FIG. 2A the user 106 is detected as an older user, and as such, the size of font 108 can be automatically increased based on the age determination of the user. Similarly, in FIG. 2B, the user is detected as a younger user, and therefore the size of the font 108 can be automatically decreased based on the age determination of the user.

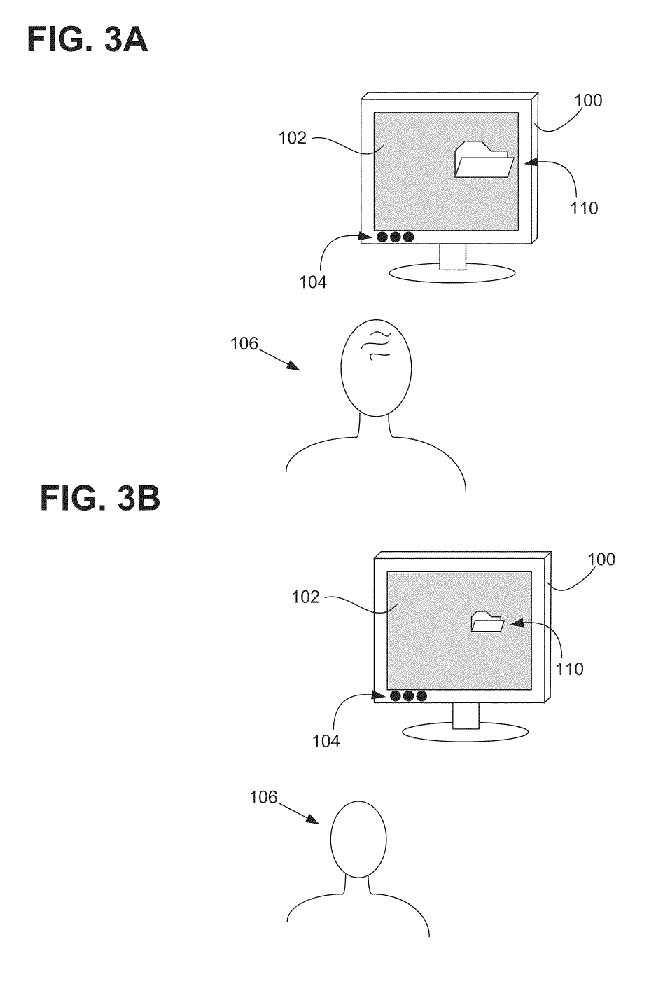

Similarly, in addition to dynamically changing the size of fonts based on the detected age of the user, the display can also automatically change the size of system icons based on the age determination of the user. Referring to FIGS. 3A-3B, in FIG. 3A the user 106 is detected as an older user, and as such, the size of system icons 110 can be automatically increased based on the age determination of the user. Similarly, in FIG. 3B, the user is detected as a younger user, and therefore the size of the system icons 110 can be automatically decreased based on the age determination of the user.

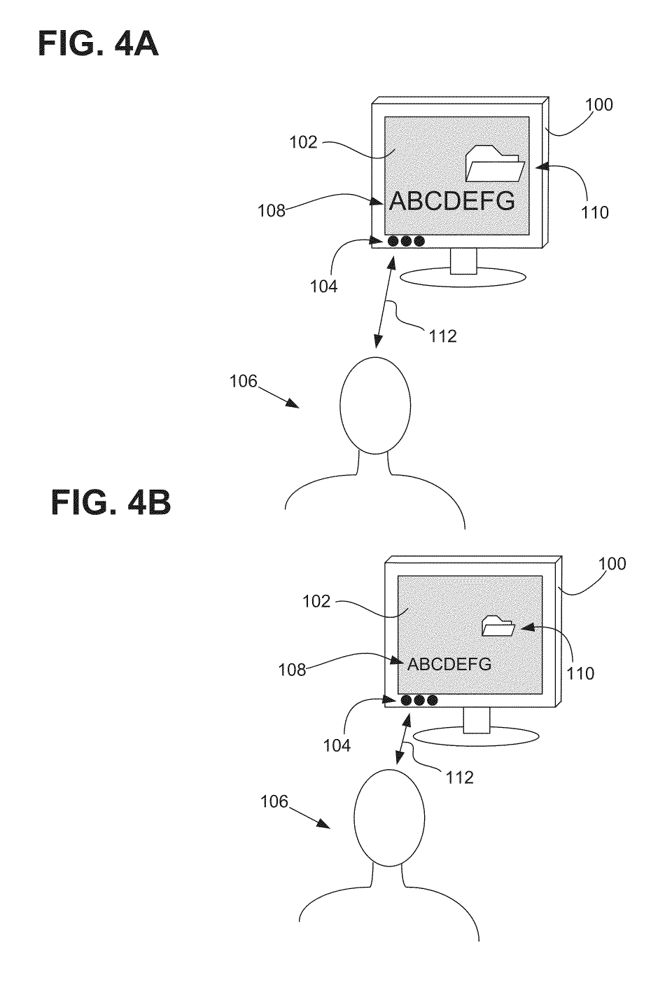

In addition to changing the size of fonts or icons based on a detected age of the user, the display can also automatically change the font and/or icon sizes based on a detected distance between the user and the display. Referring now to FIGS. 4A-4B, in FIG. 4A, as a distance 112 between the user 106 and the display 100 increases, the size of font 108 and/or icons 110 can increase on the display to aid in visualization. Similarly, in FIG. 4B, as the distance 112 between the user 106 and the display 100 decreases, the size of font 108 and/or icons 110 can decrease on the display. In one embodiment, an optimal distance for a user to be from the display can be preprogrammed (e.g., >80 cm from a 24″ screen), and the display can be configured to automatically increase or decrease the font size by a predetermined percentage for each cm or inch the user moves away or towards the display, respectively. In some embodiments, the display can consider both the age of the user and the distance of the user from the display to determine the size of the fonts and/or icons. In some embodiments, the display system can detect whether a person is having trouble viewing the display, such as by the user's detected age, his movement closer to the display, his distance from the display, detected squinting, etc. Once viewing issues are detected, the system can automatically enlarge the font and/or icon size in response.

The amount that the size of fonts and or icons is changed can be adjusted by the user or by an administrator. For example individual users may prefer larger fonts than normal when sitting at a distance, or smaller fonts when sitting close. The amount that icons change based on distance and/or age can be completely customized by the user or the administrator of the system.

The embodiments disclosed herein may be adapted for use on a television, desktop computer monitor, laptop monitor, tablet device, other mobile devices such as smart phones, and other electronic devices with displays.

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

What is claimed is:

1. A method of dynamically changing a display parameter, comprising:
detecting a user parameter of a user positioned before an electronic display; and
automatically adjusting a font size of text on the display based on the detected user parameter.

2. The method of claim 1 wherein the user parameter is an age of the user.

3. The method of claim 2 wherein the font size is increased when the user is elderly.

4. The method of claim 2 wherein the font size is decreased when the user is a child or young adult.

5. The method of claim 1 wherein the user parameter is a distance from the user to the electronic display.

6. The method of claim 5 wherein the font size is increased when the distance is greater than an optimal distance.

7. The method of claim 5 wherein the font size is decreased when the distance is less than an optimal distance.

8. The method of claim 5 wherein the font size changes dynamically in real time as the distance from the user to the electronic display changes.

9. The method of claim 8 wherein the font size is decreased in real time as the distance from the user to the electronic display becomes smaller, wherein the font size is increased in real time as the distance from the user to the electronic display becomes larger.

10. The method of claim 1 wherein the detecting step comprises detecting the user parameter with a sensor disposed on or near the electronic display.

11. The method of claim 10 wherein the sensor comprises a camera.

12. The method of claim 1 wherein the electronic display comprises a computer monitor.

13. The method of claim 1 wherein the electronic display comprises a cellular telephone.

14. The method of claim 1 wherein the automatically adjusting step comprises processing the user parameter with a controller and automatically adjusting the font size of text on the display with the controller based on the detected user parameter.

15. A method of dynamically changing a display parameter, comprising:
detecting a user parameter of a user positioned before an electronic display; and
automatically adjusting an icon size on the display based on the detected user parameter.

16. The method of claim 15 wherein the user parameter is an age of the user.

17. The method of claim 16 wherein the icon size is increased when the user is elderly.

18. The method of claim 16 wherein the icon size is decreased when the user is a child or young adult.

19. The method of claim 15 wherein the user parameter is a distance from the user to the electronic display.

20. The method of claim 19 wherein the icon size is increased when the distance is greater than an optimal distance.

21. The method of claim 19 wherein the icon size is decreased when the distance is less than an optimal distance.

22. The method of claim 1 wherein the detecting step comprises detecting the user parameter with a sensor disposed on or near the electronic display.

23. The method of claim 22 wherein the sensor comprises a camera.

24. The method of claim 15 wherein the electronic display comprises a computer monitor.

25. The method of claim 15 wherein the electronic display comprises a cellular telephone.

26. The method of claim 15 wherein the automatically adjusting step comprises processing the user parameter with a controller and automatically adjusting the font size of text on the display with the controller based on the detected user parameter.

27. The method of claim 19 wherein the icon size changes dynamically in real time as the distance from the user to the electronic display changes.

28. The method of claim 19 wherein the icon size is decreased in real time as the distance from the user to the electronic display becomes smaller, wherein the icon size is increased in real time as the distance from the user to the electronic display becomes larger.

29. An electronic display, comprising:
a sensor configured to determine a user parameter of a user positioned before the display;
a screen configured to display text or images to the user; and
a processor configured to adjust a size of the text or images based on the determined user parameter.

30. The electronic display of claim 29 wherein the user parameter is age.

31. The electronic display of claim 29 wherein the user parameter is a distance from the user to the electronic display.

32. The electronic display of claim 29 wherein the sensor comprises a camera.

33. The electronic display of claim 29 wherein the electronic display comprises a computer monitor.

34. The electronic display of claim 29 wherein the electronic display comprises a cellular telephone.

35. The electronic display of claim 29 wherein the electronic display comprises a tablet computer.
